(19) United States
(12) Patent Application Publication
(10) Pub. No.: US 2011/0299841 A1
(43) Pub. Date: Dec. 8, 2011

(54) Internal Power Driven Automatic Backdrop Apparatus

(76) Inventor: ZONGFA CHENG, NAVAN (CA)

(21) Appl. No.: 13/150,836

(22) Filed: Jun. 1, 2011

Related U.S. Application Data
(60) Provisional application No. 61/351,887, filed on Jun. 5, 2010.

(51) Int. Cl. G03B 15/00

(52) U.S. Cl. 396/3

(57) ABSTRACT

The invented apparatus is a backdrop system for displaying and storing one or several backdrops to use in a photographic studio, video productions or other instances where a backdrop may be desired and for easy carrying to on-site jobs. The backdrop is attached to a rolling system, which comprises a backdrop core in the shape of a tube or spindle and at least one roller containing an internal bi-directional drive means and a power supply unit. The rolling system is controlled by the control system containing a control unit and a command unit, thus allowing automated scrolling of different backdrop scenes and lowering a desired backdrop from a plurality of rolling systems when the appropriate scene is found. A control mechanism is applied to the backdrop system to ensure the backdrop is properly wound upon the rolling system each time. A remote control of the command unit sends command to the control unit inside the rolling system to activate, deactivate or rotate the bi-directional drive means and a microcontroller is provided for automating each task of the backdrop system as desired.

This invention relates to the use of suspended materials as a backdrop for photography, video productions or other instances. The suspended materials may be stored on a rolling system. Such rolling system may include tubes or spindles constructed of metal, of cardboard, of plastic or other lightweight and inexpensive materials. The rolling system may also include means for attaching the tube or spindle to rollers. Such attachment means may include friction, adhesive, snaps, rivets, screws, hook and latch, or the like.

### TECHNICAL FIELD

The present invention relates to photographic backdrops for use with photographs, video productions or other instances where a backdrop may be desired. More particularly, the invention relates to internal power driven control systems, devices and methods of displaying and storing backdrops.

### BACKGROUND ART

Photography or video production studios use backdrops containing various scenery pictures or color patterns as backgrounds for the portraits they create or for the use of chroma key in video production. As there are different occasions for having portraits taken and as people's tastes vary widely, portrait studios usually offer a variety of backdrop scenes. In particular, for wedding photographers and videographers, there are great needs for an easy operated and portable backdrop system to be carried for on-site services.

Therefore it would be advantageous to provide a method and a device for quickly changing a backdrop, easily controlling the moves of a backdrop roll and providing mobility for backdrop storage and travel.

### TECHNICAL PROBLEM

Some photographers have resorted to using a backdrop attached in a makeshift manner to a wall or thrown over a simple rope, wire or framework. When a change of backdrop is needed, the first backdrop is pulled down and the new backdrops is taped up or thrown over the wire or framework. This can result in damage to the backdrops which frequently cost hundreds to thousands of dollars. Moreover, it leads to a less than professional atmosphere at a photographic studio where image is paramount. When backdrops are used without a proper storage system, they are frequently stored in piles in the corner of the studio, or on storage shelves, where they may suffer additional damage.

### TECHNICAL SOLUTION

There are a couple of solutions in the past to solve the problems as described below.

In the nineties, one of the inventions provides a changeable photographic backdrop apparatus comprising a scroll with two rotatable shafts as indicated in U.S. Pat. No. 5,389,993. A web is attached at its opposite ends to the shafts and is then at least partially wound upon one or both of the shafts. The shafts and detection apparatus allow the backdrop to be quickly changed from one backdrop to another, and automatic selection from among a large number of different scenes is possible without the need to manually rotate the shafts or position the scenes.

Another solution for background support system as indicated in U.S. Pat. No. 5,799,213 or WIPO patent No. 98/57231 is to include a single-roller assembly upon which a number of backgrounds are mounted and from which any specific background is rapidly selected for display.

In the 21^{st} century, there is a couple of improvement from the 20^{th} century. One of them relates to a driving mechanism for a backdrop as indicated in WIPO patent No. 20924, in which the board roll is attached to two brackets supported by rollers. The brackets are suspended from a rope system which passes along the vertical guides and their inter-connecting cross-bar and through the rolls, and which has been adapted to lift and lower the board roll remaining in horizontal position. By pulling at the ropes, the brackets will rise, causing the drive roll of the board roll to roll out of frictional contact with the vertical guide along the guide and board is to be unwound from the roll. The board roll is lowered by releasing the rope system, so that the rotation of the drive roll in the opposite direction along the guide causes the board roll to be rewound.

A photographic backdrop with stand includes a photographic backdrop and a support structure as indicated in U.S. Pat. No. 7,236,695. The photographic backdrop includes a backdrop screen and four pockets attached to the four corners of the backdrop screen. The support structure includes a photographic light stand, a base connector and four support rods. Each support rod includes a substantially triangular end. The photographic light stand includes a vertical mounting tube. The vertical mounting tube is inserted into a bottom of the base connector. The four support rods are also inserted into pre-existing holes in the base connector. The backdrop screen is stretched over the four support rods, such that the four substantially triangular ends are inserted into the four pockets. Four extension rods may be used to extend the length of the four support rods for larger backdrop screens.

Another invention relates to the use of suspended materials as a backdrop for photography or stage productions as indicated in WIPO patent No. 131208. The suspended materials may be stored on a spool device. Such spool devices may include tubes or spindles constructed of metal, of cardboard, of plastic or of other lightweight and inexpensive materials. The spool device may also include means for attaching the tube or spindle to a lifting device. Such attachment means may include a pair of inter-connectable coupling devices, one fixed to the spool and the second attached to the lifting device.

There is a product, Manfrotto EXPAN Background Paper Drive Set With Plastic Drive Chain, selling on the market and a pair of the drive set is used for one paper roll including plastic chain and weight. The Manfrotto background support system is based on the expansion, a fast and efficient background drive set. Insert the EXPAN into the background roll, block and use the chain to roll the paper up and down as desired. A system of hooks is available in pairs and can support 1, 3 or 6 backgrounds when used in conjunction with the EXPAN. B/P Hooks can be attached to Autopole by using the Super Clamp code 035 or screwed directly onto a wall or ceiling.

It has been no internal power driven control mechanism in all of the above devices to easily manipulate the display and storage of a backdrop. Some devices are taking extra space in support system and are not portable for storage or travel. Some devices are vulnerable to maintain the backdrop not being wrinkled or damaged over a period of time.

### ADVANTAGEOUS EFFECTS

Present invention has been made by providing hardware and software solutions to solve the above problems. It is an object of the present invention to provide an apparatus with internal power driven mechanism for the ease of displaying and storing backdrops, and to provide energy saving solution for the battery that is used to drive the backdrop system of present invention via embedded software in its control unit.

### DESCRIPTION OF DRAWINGS

The foregoing and other advantages of the invention will become apparent upon reading the following detailed description and upon reference to the drawings in which:

FIG. 1 is a perspective view of one embodiment of a backdrop system according to the present invention.

FIG. 2 is a perspective view of a suspension system according to one embodiment of the present invention.

FIG. 3A is a side perspective view of a suspension system according to one embodiment of the present invention.

FIG. 3B is a detailed perspective view of one side of a suspension system according to one embodiment of the present invention.

FIG. 4A is a perspective view of a rolling system according to one embodiment of the present invention.

FIG. 4B is an exploded view of a rolling system according to one embodiment of the present invention.

FIG. 5 is a perspective view of a backdrop roller according to one embodiment of the present invention.

FIG. 6A is a section view of an active drive roller according to one embodiment of the present invention.

FIG. 6B is a section view of a passive roller according to one embodiment of the present invention.

FIG. 7 is a module view of a control system according to one embodiment of the present invention.

FIG. 8 is a block diagram of the various electrical control components according to one embodiment of the present invention.

FIG. 9A is a perspective view of a bearing block with a roller shaft installed according to one embodiment of the present invention.

FIG. 9B is a back view of a bearing block with a bearing according to one embodiment of the present invention.

FIG. 9C is a front view of a bearing block with a bearing according to one embodiment of the present invention.

FIG. 10 is a detailed perspective view of an alternative embodiment of a backdrop system according to the present invention.

### BEST MODE

In accordance with an aspect of the present invention, the above and other objects can be accomplished by the provision of an apparatus for display, storage and transportation of the backdrops, comprising a microcontroller for controlling the apparatus into sleep mode when it is not in use, at least one wireless remote control to transmit signals to the receivers inside the active drive rollers, one or more receivers to receive signals from the wireless remote control.

Preferably, the control mechanism of the internal power drive unit is made by using a microcontroller.

Preferably, the wireless remote control is powered by a battery, use learning code method to transmit signals to the receiver.

Preferably, a microcontroller is used to decode received signal and to control the bi-directional drive means.

Preferably, the wireless receiver uses rechargeable battery as power supply and uses learning code for receiving signals from the wireless remote control.

Preferably, the roller shaft connected to the internal power drive unit is made of metal material.

### MODE FOR INVENTION

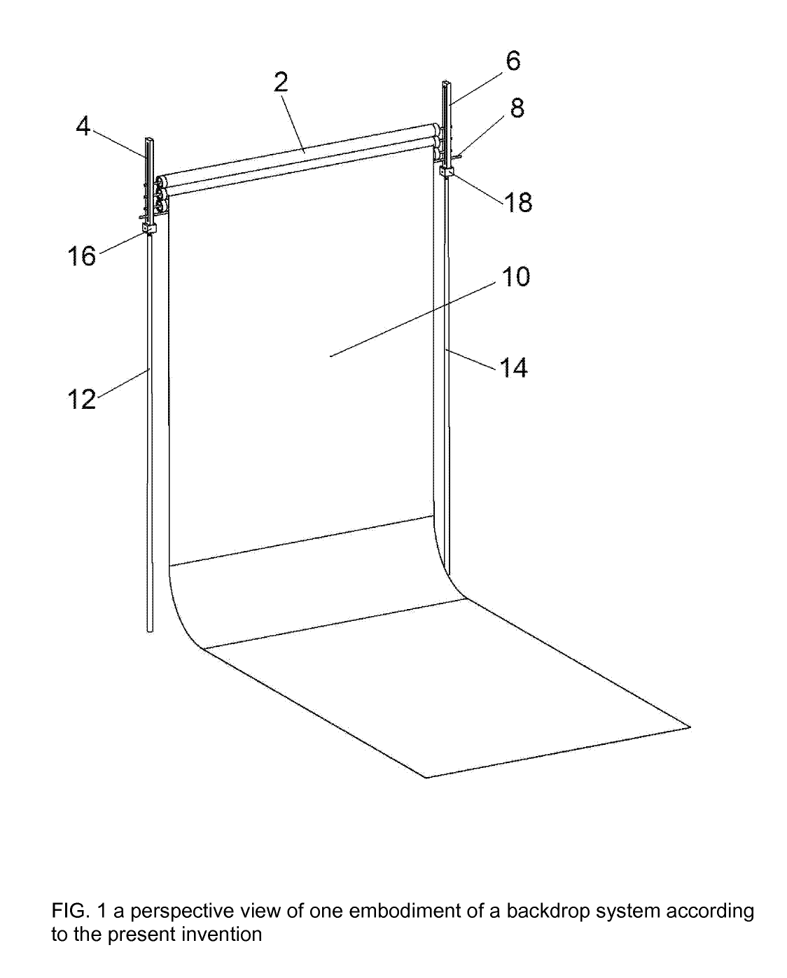

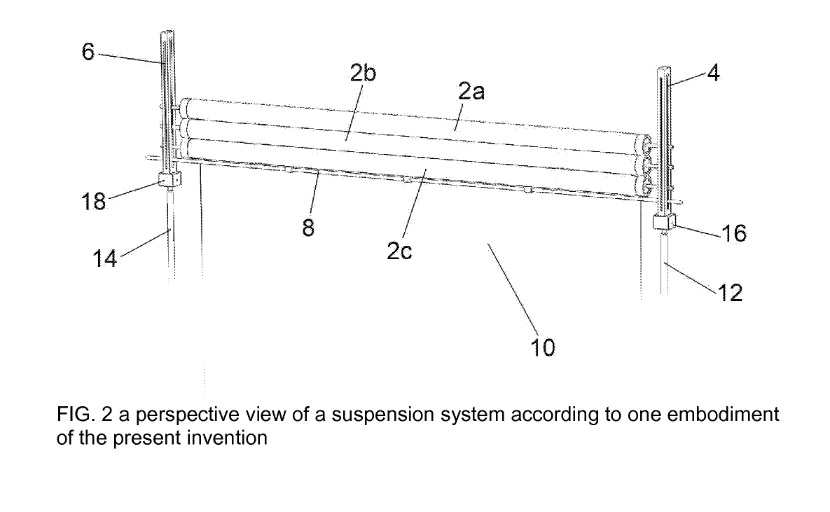

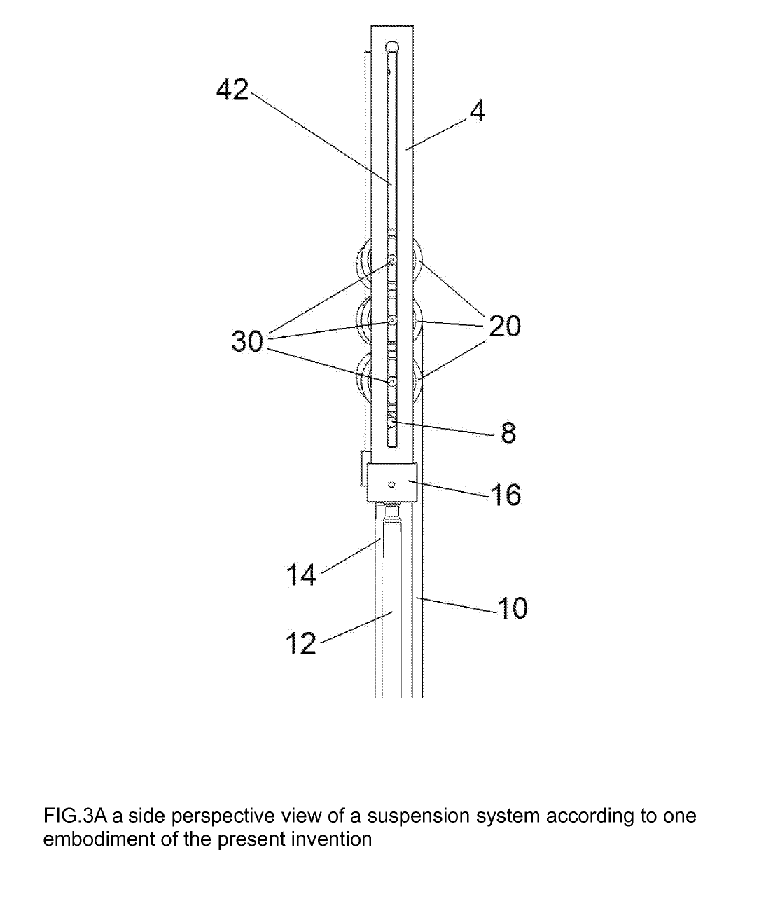

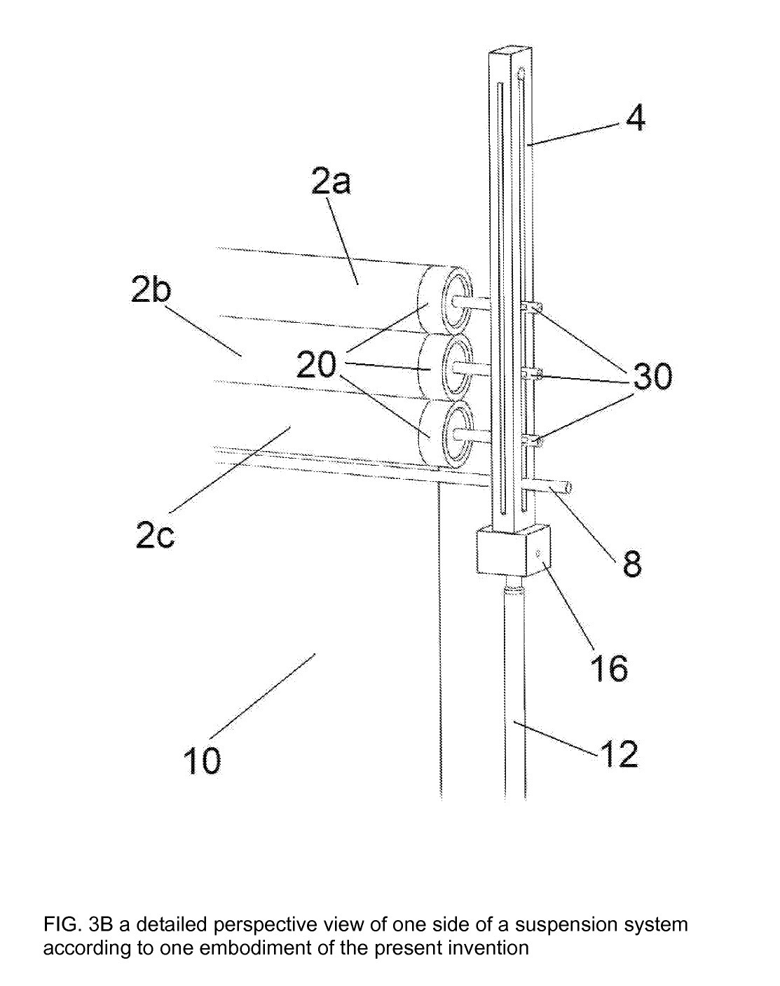

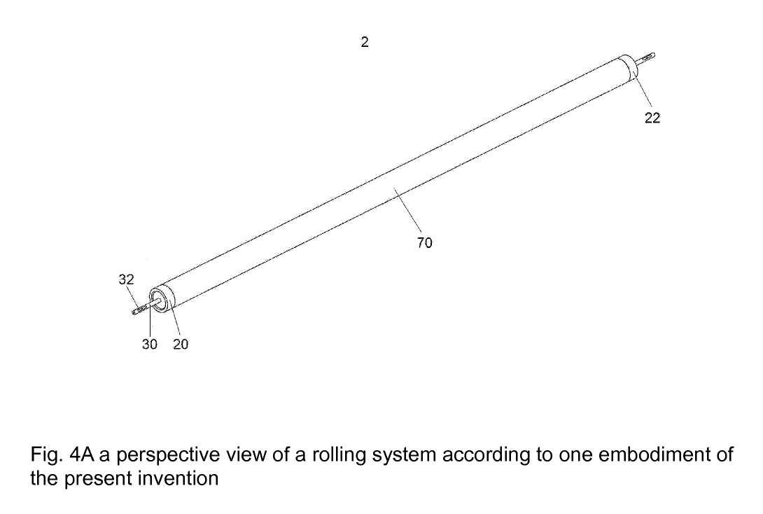

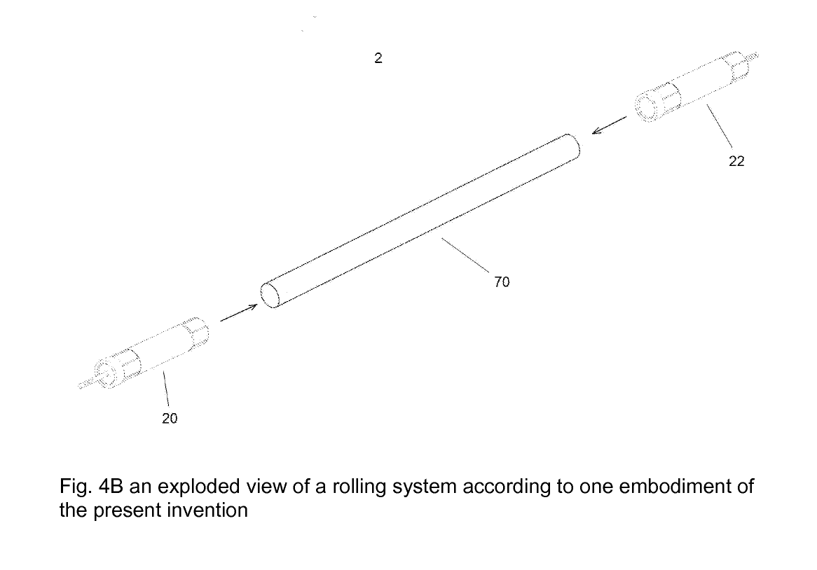

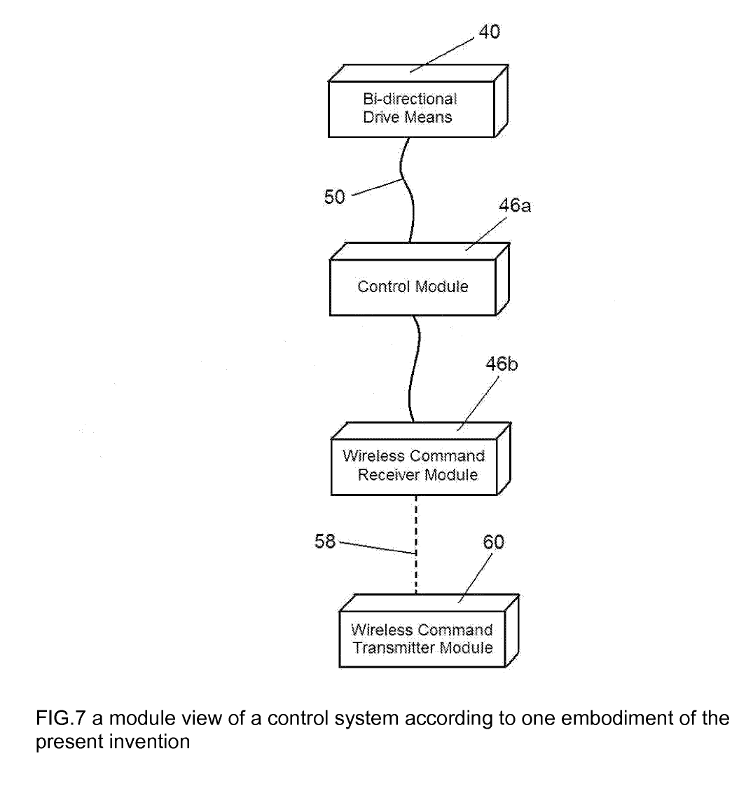

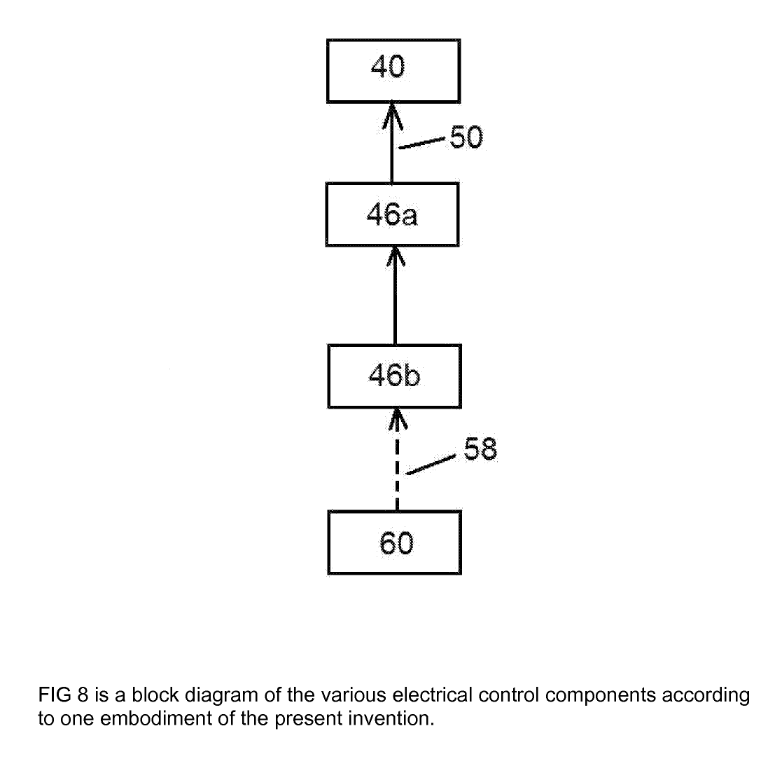

One aspect of the present invention is a backdrop system that can be used for photography, video productions or other instances where a backdrop may be desired. A backdrop system of one embodiment of present invention as shown in FIG. 1 has one or more rolling systems 2 as shown in FIG. 4A and FIG. 4B on which a backdrop can be either temporarily or permanently attached and wound in a flat and unwrinkled condition, a suspension system as shown in FIG. 2, FIG. 3A and FIG. 3B on which one or more rolling systems can be attached and suspended, and a control system as shown in FIG. 7 and FIG. 8, which controls one or more backdrops to wind upward or downward.

One embodiment of the backdrop system according to the present invention as shown in FIG. 1 has multiple rolling systems suspended at the top, while the backdrop 10 in the middle of the rolling system is selected for display and unwound downward. A shaft 8 as shown in FIG. 1, FIG. 2, FIG. 3A and FIG. 3B is placed at the bottom of the mounting brackets 4, 6 to support the weight of the three rolling systems and preventing the backdrop rolls from bending thus causing wrinkles on the backdrops, especially for long rolls.

The end connector 16 of the bracket 4 connects to the rod 12 at one side of the backdrop system and the end connector 18 of the bracket 6 connects to the rod 14 at the opposite side of the backdrop system. It may have multiple rolling systems suspended on the bracket 4 and bracket 6.

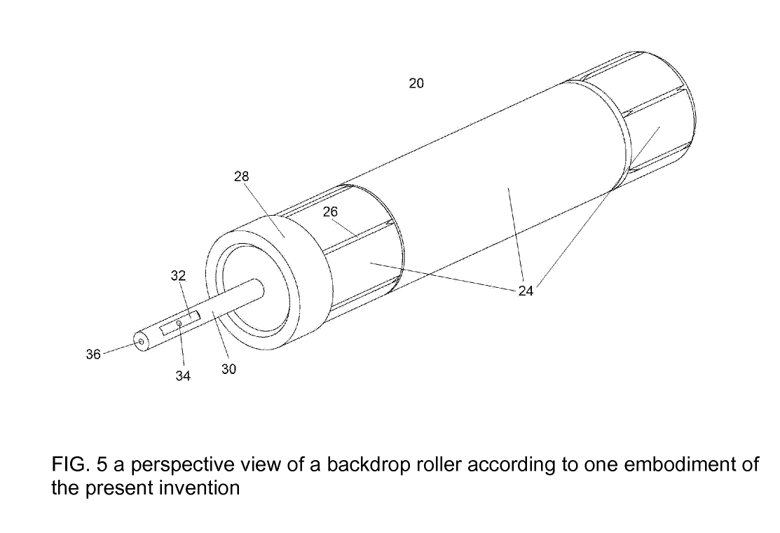

A rolling system 2 according to one embodiment of the present invention as shown in FIG. 4A and FIG. 4B is comprised of a backdrop core 70 which can be made of cardboard, aluminum, plastic or other suitable materials on which a backdrop can be wound or unwound, an active drive roller 20 as shown in FIG. 5, 6A with an internal bi-directional drive means 40 and a passive roller 22 as shown in FIG. 5, 6B without an internal bi-directional drive means 40. Alternately both rollers 20,22 can be configured to be active drive rollers in order to rotate and support a longer or heavier backdrops.

The active drive roller 20 can be inserted into one end of the backdrop core 70 while another roller 22, either passive or active, can be inserted into the opposite end of the core 70. The attachment of the core 70 with the rollers 20 and 22 can be adhesives, screws, or frictional contact. The rolling system 2 can be configured with either internal bi-directional drive means 40 in one roller only or in both rollers depending on the weight or dimension of a backdrop.

One embodiment of a suspension system according the present invention is comprised of mounting brackets 4, 6 which connected via end base connectors 16, 18 to supporting rods 12, 14 as shown in FIGS. 1, 2, 3A and 3B. The mounting bracket 4 or 6 is provided for attaching the roller 20 or 22 on which a backdrop roll can be rotated upward or downward. The rollers are placed inside a backdrop core 70 as shown in FIG. 4A, 4B and can move vertically along the tracks 42 on the brackets.

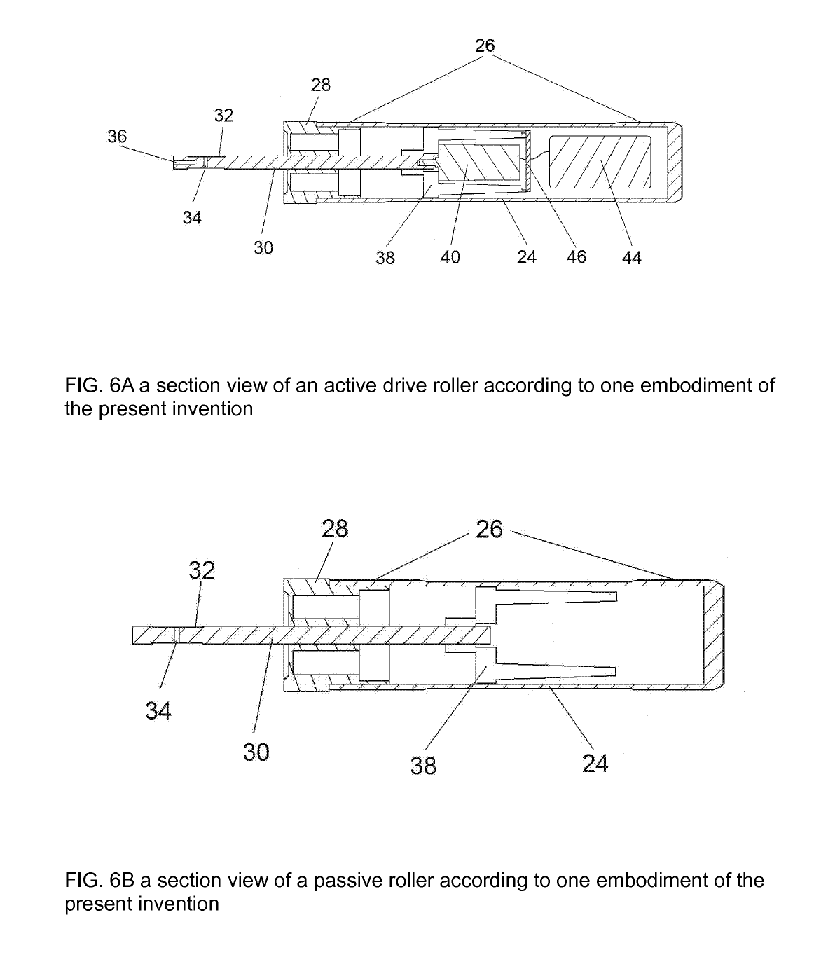

A bi-directional drive means such as a gear motor 40 inside an active drive roller 20 as shown in FIG. 6A is used to drive the rolling system 2 for the display or storage of a backdrop.

One embodiment of a roller according to the present invention as shown in FIG. 5, FIG. 6A and FIG. 6B is comprised of a combination of a tube 24 as main body of the roller, a bi-directional drive means 40 such as a gear motor or the like, a control unit 46 containing a control unit which is connected to the bi-directional drive means 40 to activate, deactivate, rotate or stop the drive and a microcontroller which programmed to receive and decode commands from a command transmitter and to set sleep mode for the bi-directional drive means 40 when it is not in use and to rotate the bi-directional drive means 40 once in a while to ensure the backdrop is not wrinkled or damaged during long period of time in sleep mode, a fixture 38 which is made of rigid material such as PVC or the like to fix the bi-directional drive means 40 in position and to support the control unit 46 attached to it, a power unit such as a battery pack 44 that is connected to the control unit 46 to supply the power of the internal drive system, a roller shaft 30 which is connected to the internal bi-directional drive means 40 and is also extended to the outside of the tube 24 for mounting on the brackets of a suspension system, and a bearing block 28 which is made of rigid material for covering the tube and bearing the roller shaft 30 as well as blocking the backdrop core 70 from moving horizontally. The ribs 26 with wedge at one end or both ends attached to the tube 24 are for easily attaching the rollers 20, 22 inside the backdrop core 70 and in frictional contact with the core.

The shaft 30 of a roller according to the present invention is actually the ONLY is fix part that is NOT turning while all other parts of the roller are the turning parts once the internal bi-directional drive means 40 being activated. This unique design makes the backdrop rollers both the active drive roller 20 and the passive roller 22 act with the backdrop core 70 in an integrated manner. Most parts of the active drive roller and the passive roller are placed inside of the backdrop core. The advantage of being easily to install and store a backdrop is obvious.

Unlike other invention, in the present invention, even from the power switch to the internal power drive unit will be rolling with the rollers when the internal bi-directional drive means is active. Therefore using remote control to activate or deactivate this system is needed.

The slot 32 is used for the locking position on the roller shaft, and the lock 34 according to one embodiment of the present invention is for locking the roller shaft of the rolling system on the bracket of a suspension system. The end socket 36 (optional) of a roller shaft is used for plugging in a cable connector of a battery charger to charge the battery inside an active drive roller. The control system can be configured to rotate the rolling system 2 in two directions, either clock-wise or counter clock-wise. The rolling system 2 is easily removable from the brackets 4,6 of a suspension system, and the backdrop 10 can be removed from the rolling system 2 when it is no longer in use. The rollers 20, 22 can be easily attached to and removed from various backdrop rolls that come with a core 70, such as a backdrop paper roll with a cardboard core, while the core may be constructed using suitable materials such as cardboard, aluminum, plastic, metal or the like when there is no core supplied with a backdrop such as a muslin backdrop.

The attachment of a rolling system 2 and a mounting bracket 4 or 6 can be made by inserting the roller shaft 30 of a roller 20 or 22 referred as a male mating member into the track of a mounting bracket 4 or 6 referred as a female mating member to the locked position. When the rolling system 2 is in the attached and rotated position, optionally, a lock may be engaged to secure the rolling system 2 to the mounting bracket 4 or 6.

A control system according to one embodiment of present invention as shown in FIGS. 7 and 8 is comprised of a control module 46a which controls the bi-directional drive means 40 to rotate clockwise or counter clockwise, a wireless command receiver module 46b and a wireless command transmitter module 60 such as a remote wireless control. The wireless command transmitter module 60 sends encoded command signal to the wireless command receiver module 46b via wireless mechanism 58, the wireless command receiver module 46b in turn sends decoded command signal to the control module 46a. The control module 46a interprets these various signals and processes them into commands to activate, deactivate, or cause the bi-directional drive means 40 to rotate in an appropriate manner.

A control unit 46 as shown in FIGS. 6A, 7 and 8 is comprised of a control module 46a and a wireless command receiver module 46b. The control unit 46 is connected to the bi-directional drive means 40 via a control module cable 50.

Referring to FIGS. 7 and 8, input commands to bi-directional drive means 40 such as a gear motor consist of energizing or de-energizing the gear motor, and providing bi-directional rotation to the gear motor, thusly raising or lowering a backdrop as commanded. This control system is virtually identical to that employed in the raising or lowering of an electrically controlled car window. With respect to the control system under discussion, actuation and bi-directional rotation control of gear motor 40 is provided utilizing wireless transmission technologies. wireless command transmitter module 60 has pushing buttons (not shown) to send an encoded command to wireless command receiver module 46b which is in turn connected electrically to control module 46a which will in turn drive gear motor 40 as directed.

Pushing a button on the wireless command module 60 (not shown) in one direction energizes a relay in control module 46a, which directs gear motor 40 to rotate in a given direction. Release of pressure on the control button allows it to return to its spring-loaded off position, and the relay mentioned above is de-energized, thus causing gear motor 40 to stop. Alternately, pushing a button (not shown) in an opposite direction energizes a second relay in control module 46a, directing gear motor 40 to rotate in the opposite direction.

As discussed earlier, bi-directional drive control of an active drive roller 20 will be provided by an electric motor operating system which must provide the drive roller 20 with the following five operational control functions: rotation starts up, rotation stop, forward rotation, reverse rotation, and rotation lock up. The configuration and operational characteristics of the systems have been discussed previously at length, and need no restatement.

FIG. 8 is a block schematic of the various electrical components utilized to provide rotational control of an active drive roller. Control module 46a accepts a signal from a wireless transmitted signal generated by command transmitter module 60 via command receiver module 46b. Control module 46a interprets various signals and processes them into commands to activate, deactivate, or cause gear motor 40 to rotate in an appropriate manner.

While the invention has been described with reference to at least one preferred embodiment, it is to be clearly understood by those skilled in the art that the invention is not limited thereto. Rather, the scope of the invention is to be interpreted only in conjunction with the appended claims.

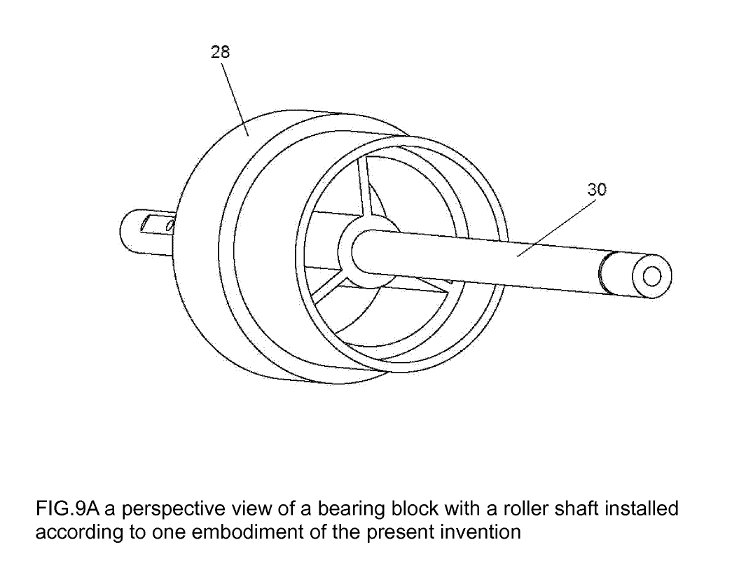

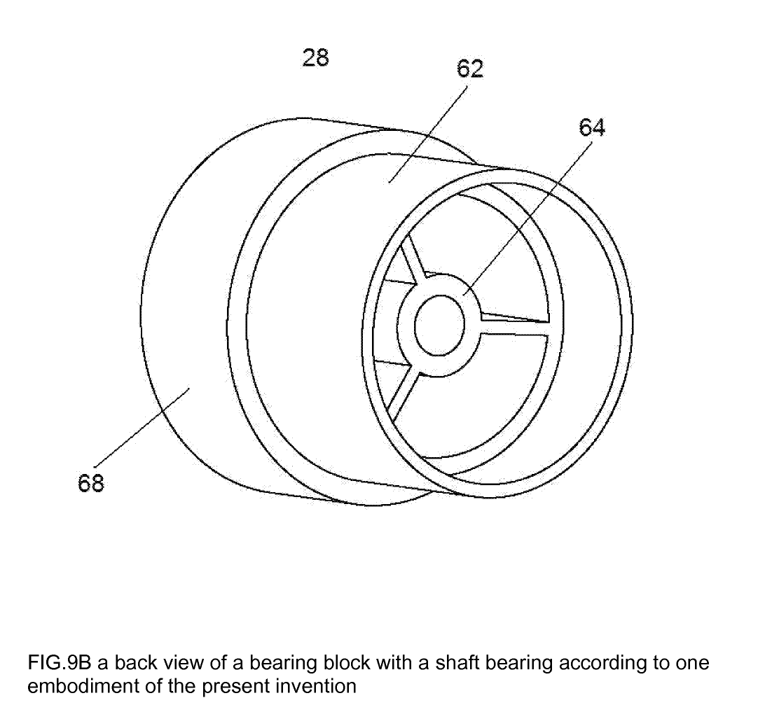

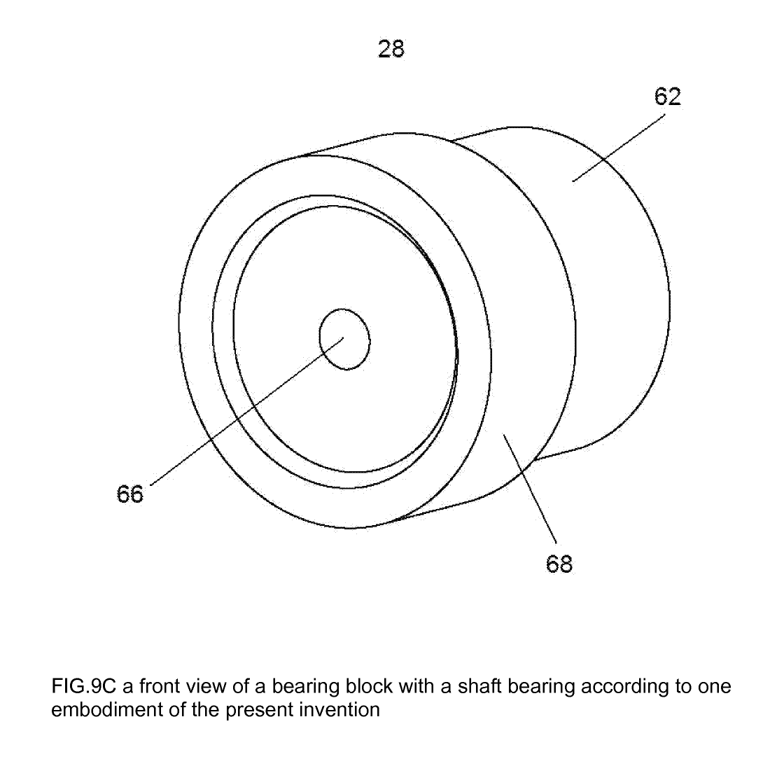

A bearing block 28 of one embodiment according to the present invention as shown in FIGS. 5, 9B and 9C is made of a rigid material such as PVC or the like to cover the tube 24 of a roller 20 or 22. The bearing black 28 is constructed by three parts, first part is a top unit 68 made to cover the tube 24, the second part is a side unit 62 which is used for attaching the bearing block 28 to the inside of the tube 24 and the third part is an inner unit 64 for bearing the roller shaft 30 of the roller 20 or 22 as shown in FIG. 9. An open hole 66 on the top unit 68 shown in FIG. 9C, whose inner diameter matches the outer diameter of the shaft 30, is also used for bearing the roller shaft 30 and allowing the shaft 30 to be extended outward from the roller 20 or 22.

For many uses of a backdrop system, it may be desirable to have more than one backdrop. In such instances, the system may have a plurality of backdrops. The plurality of backdrops may each be secured on a separate backdrop core or stored by other means and fastened, each in turn of use, to the same or separate rolling system. The plurality of backdrop rolls may be stored, for example, on a storage rack. Additionally, the backdrop rolls may be configured to receive a storage stopper in an end and be propped against a wall for storage. The backdrop system may be configured to form various rolling systems in order to accommodate and adjust for backdrop rolls of varying lengths.

The backdrop core has an elongated tube portion with a first end and a second end. Adjacent both the first end and the second end of the core, a roller is presented. The roller may comprise attachment points for receiving mating members of the core. Further the roller may have a lock for securing the backdrop core to the roller. Such locks may be a locking pin. Further the locks may be friction, a hook and latch, a snap, a rivet, a screw, adhesive, or the like.

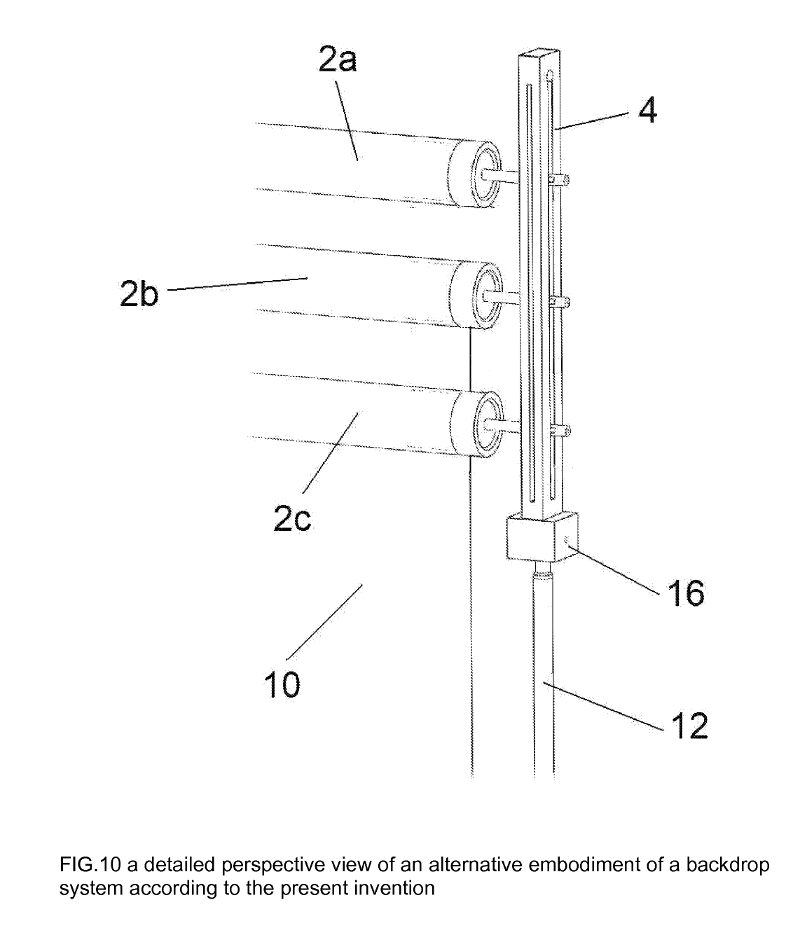

One embodiment of a backdrop system according to present invention as shown in FIG. 1 has one or more rolling systems attached to a suspension system and one of the backdrops may be selected and wound downward for display and the other backdrops may be wound upward for temporary or permanent storage. When a backdrop is made of paper or the like, a shaft 8 as shown in FIGS. 1 and 2 may be placed at the bottom of the mounting brackets 4 and 6 to support the weight of the rolling systems above it and to prevent the deformation of the backdrop rolls, it may also tighten the roll at the bottom when it is wound up. All the rolling systems can be stacked together on the mounting brackets. When wound up, each roll will be firmly tightened up by the friction between each other. When a backdrop is made of a cotton cloth such as a muslin backdrop or the like, an alternative backdrop system may be configured as shown in FIG. 10. One or more rolling systems suspended on the mounting brackets may have space between adjacent rolls and a shaft 8 may not be needed at the bottom of the mounting bracket. The rolling of the backdrops on the rolling systems may be controlled by a remote control.

A control system according to one embodiment of the present invention may be configured to wind one or more backdrops upward or downward from corresponding rolling systems. For example, to wind one of the backdrops downward for display and the other backdrops upward for temporary or permanent storage.

One embodiment of a multi-roll-configured backdrop system according to the present invention as shown in FIG. 1 has a unique control scheme that the control unit 46 is programmed in such way that one and only one backdrop roll is wound downward while all others are wound upward. The advantage of such control scheme is that the adjacent rolls interact to each other. Since the one being wound downward to display is turned in different direction with respect with the adjacent rolls that is being wound upward, it make the desired backdrop to roll out easily and interact smoothly with its adjacent rolls. This interaction also make the adjacent rolls wound up firmly. When wound up firmly, the backdrop rolls have more resistance against to its deformation. According this control scheme mentioned above, the remote control 60 can send a single designated command to inform all the rollers of the multi-roll-configured backdrop system wound up when the system is not longer in use for a period of time. When all the rolls are wound up, the friction between the adjacent rolls against each other, make the rolls tight and firm. Firmly wound rolls will resist to bending or deforming when they are not been used for relatively long period time.

Once the rolling system is removed from the suspension system, the backdrop roll may be removed from the rolling system by detaching all the rollers from the backdrop core. A second backdrop roll may then be obtained and attached to the rolling system by re-attaching the rollers to both ends of the backdrop core, and the rolling system is re-attached to the suspension system and raised to the first height.

Other features and advantages of the present invention will become apparent to those of skill in the art through consideration of the ensuing description, the accompanying drawings, and the appended claims.

Although the foregoing description contains many specifics, these should not be construed as limiting the scope of the present invention, but merely as providing illustrations of some exemplary embodiments. Similarly, other embodiments of the invention may be devised that do not depart from the spirit or scope of the present invention. Features from different embodiments may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

Referring to FIG. 1 a backdrop system is presented. The backdrop system can be used in for example a photographer's studio, in video or stage productions, or other instances. The backdrop system has a rolling system 2 that can be suspended on a suspension system FIGS. 2, 3A and 3B. The rolling system 2 is configured to receive thereon a backdrop 10. The backdrop 10 can be a paper backdrop, a fabric backdrop or other flexible materials that can be wound on the rolling system 2. The backdrop 10 can have a scene presenting the illusion of another place. Alternatively the backdrop may be dyed, colored, or painted to present a suitable background for a photograph, video conference, video or stage production, or other event.

A rolling system 2 can be suspended on a suspension system as shown in FIGS. 2, 3A and 3B. The rolling system 2 has two rollers 20, 22 as shown in FIG. 4A, 4B. A roller comprises a roller shaft 30 for mounting on either end of the mounting bracket 4 or 6, and a combination of a tube 24, ribs 26, bearing block 28, fixture 38, a motor 40, and a power unit 44. A roller can be attached to either ends of a backdrop core 70. The core 70 and the two rollers 20, 22 are attached via friction, a hook and latch, a snap, a rivet, a screw, adhesive, or the like such as the ribs 26 in FIG. 5. It will be appreciated that any rigid material may be used in place of the tube 24, ribs 26, bearing block 28 and fixture 38 such as PVC or the like. In one present embodiment PVC is used. The roller shaft 30 can be made of a high-strength material or the like such as steel.

The rolling system 2 may be turned by an electric motor 40 in FIG. 6A or other drive means. This embodiment is such that when the rolling system 2 is turned in one circular direction, the backdrop 10 is wound upward or downward around the backdrop core 70. When the rolling system 2 is operated in the opposite direction, the backdrop 10 is reversely wound downward or upward around the core 70.

Referring now to FIGS. 4A and 4B, one embodiment of a rolling system 2 is presented. The rolling system 2 has an elongated cylinder referred herein as backdrop core 70. The core 70 may be a hollow tube of such material as cardboard, metal, plastic or fiber glass. Alternatively the core 70 may be a solid structure such as a wood dowel with receptors to the internal powered driving device. In one present embodiment, the core 70 is a cardboard tube having a diameter of about 2 inches. It will be appreciated that the length and diameter of the core 70 may vary depending on the desired use of a backdrop system according to the present invention.

The rolling system 2 can also have two rollers 20, 22 as shown in FIG. 4B. The backdrop rollers 20, 22 can have fasteners 26 or the like as shown in FIG. 5 whereby the backdrop core 70 may be secured to the rollers 20, 22. In the illustrated embodiment, the fasteners 26 are friction type fasteners. Alternatively other fasteners 26 may be used such as hooks and latches, adhesives, snaps, rivets, screws, and the like. In such embodiments, the friction of the backdrop core 70 with the backdrop rollers 20, 22 may suffice to hold the backdrop core 70 during the rotation of the rolling system 2. The core 70 has two ends and the rollers 20, 22 can be attached to both ends of the backdrop score 70. The rollers 20, 22 can be constructed independently from the core 70. The rollers 20, 22 can be molded from plastic, or may be cut or molded from wood, cardboard, metal, fiberglass, and the like.

Two particular embodiments of roller 20 or 22 are shown in more detail in FIGS. 6A and 6B. The roller 20 has an inner tube 24 and an outer bearing block 28. The inner tube 24 has a roller shaft 30 extending away from the bearing block 28. The tube 24 has an outside diameter that is selected to fit snugly within the inside diameter of the tubular cylinder of the core 70. A series of ribs 26 are run the length of the inside diameter of the core 70. The ribs 26 serve the purpose of providing friction contact if the roller is to be attached to the core 70. Alternatively, the roller 20 may secured to the cylinder core 70 by an adhesive or the like.

The outer bearing block 28 has an inner bearing 64 and a hole 66 at the top for protruding the roller shaft to the outside of the roller. As will be discussed below, the roller shaft 30 serves as a male mounting shaft for the attachment of the roller 20 or 22 to the female mounting bracket 4 or 6 of the suspension system.

One embodiment of a roller 20 is shown in FIG. 5, 6A. The roller 20 has one roller shaft 30 connected to a bi-directional drive means 40 inside the tube 24 and extended to the outside of the tube as a male mounting shaft. The roller shaft 30 and the bi-directional drive means 40 create an internal drive power for rotating the backdrop core 70 that attached to the roller. The cylinder core 70 can be coated with a non-slip surface or may be lined on the exterior with a rubbery material to provide a tactile surface for gripping the roller 20. Alternately, another embodiment of a roller 20 is shown in FIG. 5, 6B which is similar to the roller in FIG. 6A with the exception of no internal bi-directional drive means constructed.

The cylinder core 70 can be an integrated part of one embodiment of the rolling system 2. Alternatively, a short fixture 38 for the bi-directional drive means and the bearing block for the cylinder core 70 can be secured by friction, adhesive, snaps, rivets, screws, hook and latch, or the like. The roller shaft 30 extends outwardly from the cylinder core 70.

Referring to FIGS. 4B, 5 and 9B, the roller 20, 22 of the rolling system 2 has an inner tube 24 and an outer bearing block 28. The outer bearing block 28 of the roller 20, 22 that will be positioned next to the tube 24 of the roller has an inner ring 62 which can be inserted into the tube 24 and secured by adhesives, screws, or friction. Alternatively, the bearing block 28 may be molded as an integral part of the roller 20, 22. The roller 20, 22 serves as male mating members and the backdrop core 70 serves as female mating members for their attachment in the rolling system 2.

A lock hole 34 as shown in FIGS. 5, 6A and 6B is located on the outer roller shaft 30 of the roller 20, 22. The lock hole of the illustrated embodiment is made for a pin lock. The pin lock may include a bushing molded into the lock hole of the outer roller shaft 30. The bushing may be made of metal such as brass. The pin is locked in place in the position of the hole 34 which provides a locking function against the rotational motion of backdrop mating roller 20, 22 and cannot move without the imposition of some force.

Referring to FIGS. 4B and 5, the attachment of rollers 20, 22 to the backdrop core 70 is illustrated. The attachment is made by inserting the ribs 26 of the rollers 20, 22 into the core 70. When both ends of the core 70 are attached to the ribs 26 of the rollers 20, 22, the assembled rolling system 2 is then rotatable by positioning the elongated slots 32 of the roller 20, 22 onto the track 42 of the mounting brackets. The connected rollers 20, 22 can be locked in place on the mounting brackets 4, 6 by pushing lock pin into the lock hole 34 of the roller 20, 22.

Other locks can be used to lock the connected rollers 20, 22 on the mounting brackets 4, 6 together. For example, a locking segment (not shown) can be attached to a spring steel strip fastened to the opposite side of track 42 from the brackets 4 and 6, taking the place of lock pin assembly 34. When rollers 20, 22 are at their extreme rotated position, the spring strip moves a lock block into a space in both mating roller shaft of rollers 20, 22 and prevents further roller shaft 30 rotation with relation to the bracket 4, 6.

In certain embodiments the roller 20 or 22 has a short tube section (not shown) that is fastened permanently into, and extents inwardly to the bottom of the roller and fit snuggly within the inner diameter of the corresponding roller. This tube section provides shear strength to the combined roller shaft 30 and inner fixture 38 assembly.

Referring now to FIG. 10, an alternative embodiment of the backdrop system is shown. In this embodiment, much of the backdrop system remains the same as the first described embodiment shown in FIG. 1. However, one or more rolling systems may be suspended and placed in position on the mounting brackets 4, 6, there may be certain space between adjacent backdrop rolls and no shaft may be placed below all the rolls. Further, each rolling system 2a, 2b, 2c can be controlled independently to wind upward or downward by remote controls. This embodiment may be used as a standalone product or may easily be retrofitted to the backdrop system in FIG. 1.

Alternative embodiment of a suspension system (not shown) may be consist of a pair of rods or poles secured from ceiling to floor or from wall to wall using auto locking mechanism and one or more sets of clamps to secure the rolling system. While another alternative embodiment of a suspension system may be comprised of a pair of mounting brackets to be mounted on the ceiling or on a wall or onto stands/tripods and can be used to hook up plurality of rolling systems. Other embodiment of the suspension system or the backdrop system according to the present invention may vary greatly depending on the engineering or product design.

Following completion of the photo session, all backdrops will be wound upwardly on the rolling systems in preparation for storage either temporarily on the suspension system or permanently taking to a storage room. When the backdrop is stored on the suspension system, the control system can be configured to rotate the rolling system upward periodically in an angle clockwise or anti-clockwise to keep the backdrop rolls in straight shape horizontally and to prevent the deformation of the roll, especially in the case of a long roll. When a backdrop is going to be sent to a storage room, upward motion of the rolling system will be ceased, the rolling system is removed from the suspension system, the rollers are removed from the backdrop core and the backdrop can be stored permanently in a storage room.

The backdrop system as shown in FIG. 1 is primarily intended for use in a photographic studio, video production or other instances. This apparatus may be mounted directly on a wall, suspended from a ceiling, or suspended from a freestanding structure in any conventional fashion. As shown in FIG. 1, the preferred embodiment calls for its mounting on a freestanding structure for the ease of backdrop suspension and removal as well as mobility for travel. Backdrop support system contains backdrop core 70 supported by two rollers 20 and 22, mounting brackets 4, 6 and rods 12, 14. These two rollers 20, 22 are supported by mounting brackets 4, 6 bearing a backdrop roll, while rods 12, 14 are used for bearing the mounting brackets. The diameter of the core 70 will range nominally between 2.0 cm and 15 cm, and its length will be 2 cm to 30 cm longer than the maximum width of background sheets attached to it. For most photographic studio applications, this length ranges from 1.30 meters to 6 meters, although any suitable length may be selected. The physical characteristics of core 70, its diameter, wall thickness, and the material, of which it is constructed, will depend upon the combined weight of the background sheets it must support. Cardboard, PVC, aluminum or other suitable materials may be used to construct the core to suite the dimension and weight of a selected backdrop.

Once the rolling system 2 is removed from the suspension system, a user may detach the rolling system 2 from mounting brackets 4, 6 of the suspension system. In the illustrated embodiment, the removal of the rolling system is accomplished by sliding the locking pin (not shown) from a locked position of the lock hole 34 to an unlocked position. Once the rolling system 2 is unlocked, the rollers 20, 22 may then be removed from the backdrop core 70 and the backdrop or backdrop roll is detached from the rolling system 2.

A second backdrop or backdrop roll may then be obtained and attached to the rolling system 2. The attachment is done by reversing the detachment steps, namely, inserting the rollers 20, 22 into the core 70 until the ribs are covered completely by both ends of core 70. The lock for securing the rolling system 2 is in place on suspension system. The second backdrop roll may then be raised back up to a position at or near the first position.

It will be appreciated that at certain times it may be advantageous not to have any backdrop 10 or backdrop core 70 on the suspension system.

### INDUSTRIAL APPLICABILITY

As is apparent from the above description, in accordance with the present invention, when a backdrop is attached to the rolling system, an active drive roller with internal bi-directional drive means and a passive roller or a second drive roller are attached at both ends of the backdrop core and are mounted on the suspension system, the wound or unwound of the backdrop is achieved via a wireless control system, so that the hassle of setting up and wiring an external bi-directional drive means is eliminated, thereby provide a feasible solution to a production line.

What is claimed is:

1. A backdrop system comprising: a rolling system for receiving and rotating thereon a backdrop; a suspension system for supporting thereon said rolling system; a control system for starting, stopping, forward and reverse rotating said rolling system.

2. The system of claim 1, wherein the improvement further comprises a bi-directional drive means housed within said rolling system and reversely used for rolling and unrolling thereof. Whereby the output shaft of said bi-directional drive means is fixed and extended for mounting on said suspension system and all other members of said bi-directional drive means are rotated.

3. The system of claim 2, wherein said suspension system comprises mounting brackets as female mating member for receiving said rolling system.

4. The system of claim 2, wherein said control system comprises a control unit for starting, stopping, forward and reverse rotating said bi-directional drive means; and a command unit for sending user commands to said control unit.

5. The system of claim 4, wherein said control unit is configured to set sleep mode for said bi-directional drive means when it is not in use for a certain period of time or to rotate the backdrop upward periodically in an angle clockwise or anti-clockwise to keep the backdrop rolls in straight shape horizontally and to prevent the deformation of the backdrop roll, especially in the case of a long roll.

6. The system of claim 2, wherein said rolling system comprises a backdrop core for receiving thereon said backdrop; and at least one roller attached inwardly to said backdrop core for rolling and unrolling thereof.

7. The system of claim 6, wherein said roller containing a device selected from the group consisting of a tube with an attachment mount for mounting thereon said backdrop core, at least one roller shaft protruding from said roller as male mating member for mounting said rolling system to the mounting brackets of said suspension system, at least one bearing block as an integral piece of said roller for covering up the end of said tube and bearing said roller shaft, a bi-directional drive means housed within said roller for rolling and unrolling said roller, a control unit housed within said roller for controlling said bi-directional drive means, a power unit housed within said roller as power supply for said bi-directional drive means and said control unit, and fixtures for holding all housed members internally within said roller. (device claim)

8. The system of claim 2, further comprising a plurality of rolling systems for receiving thereon a plurality of backdrops, each rolling system configured to be mountable to and removable from said suspension system.

9. The system of claim 8, wherein each of the plurality of backdrops is stored on a separate rolling system.

10. The system of claim 9, wherein each of the plurality of rolling system is mounted seamlessly to its adjacent rolling system on the mounting brackets of said suspension system such that each backdrop on each of the plurality of rolling system is tightened up by its own rotation in one direction and by its adjacent backdrop's rotation in the opposite direction respectively to prevent deformation of all the backdrops in the backdrop system.

11. The system of claim 2, further comprising a plurality of backdrops configured to be separately received upon said rolling system.

12. The system of claim 1, further comprising a backdrop core for receiving thereon said backdrop; at least one roller attached inwardly to said backdrop core for rolling and unrolling thereof; mounting brackets as female mating member for receiving said roller; a tube as member of said roller containing an attachment mount for mounting thereon said backdrop core; a roller shaft protruding from said roller as male mating member for mounting said roller to said mounting brackets; at least one bearing block as an integral piece of said roller for covering up the end of said tube and bearing said roller shaft; a bi-directional drive means housed within said roller for rolling and unrolling thereof; a control unit housed within said roller for starting, stopping, forward and reversely rotating said bi-directional drive means; a power unit housed within said roller as power supply for said bi-directional drive means and said control unit; fixtures for holding all housed members of said roller internally within thereof; and a command unit for sending user commands to said control unit. (system claim)

13. The system of claim 12, further comprising a plurality of backdrops; wherein each of the plurality of backdrops is wound upon a separate backdrop core.

14. The system of claim 12, further comprising a plurality of backdrops configured to be separately received upon said backdrop core.

15. The system of claim 13, wherein each of the plurality of backdrops is configured to be mountable to and removable from said mounting brackets.

16. The system of claim 13, wherein each of the plurality of backdrops is mounted seamlessly to its adjacent backdrop on said mounting brackets such that each of the plurality of backdrops is tightened up by its own rotation and by its adjacent backdrop's rotation in an opposite direction respectively to prevent deformation of all the backdrops in said backdrop system.

17. A method of rolling and unrolling a backdrop comprising:
a. providing a backdrop core for receiving thereon a backdrop
b. providing mounting brackets for suspending said backdrop wound upon said backdrop core
c. providing at least one roller containing a device selected from the group consisting of a tube with an attachment mount for mounting thereon said backdrop core, a bi-directional drive means housed within said roller for rolling and unrolling thereof, a control unit housed within said roller for starting, stopping, forward and reverse rotating said bi-directional drive means, a power unit housed within said roller as power supply for said bi-directional drive means and said control unit, at least one roller shaft protruding from said roller for mounting thereof to said mounting brackets, at least one bearing block as an integral piece of said roller for covering up the end of said tube and bearing said roller shaft, and fixtures for holding all housed members internally within said roller, and
d. providing a remote control for transmitting user commands to said control unit, whereby said backdrop can be rotated downward for display or upward for storage temporarily or permanently.

18. The method claim of 17, wherein said bi-directional drive means is reversely used for rotating said roller. Whereby the output shaft of said bi-directional drive means is fixed and extended for mounting on said mounting brackets and all other members of said bi-directional drive means are rotated.

19. The method claim of 17, wherein said roller is removable and attachable to said backdrop core.
